(19) United States
(12) Patent Application Publication
(10) Pub. No.: US 2023/0003127 A1
(43) Pub. Date: Jan. 5, 2023

(54) RECPROCATING IC ENGINES WITHIN THERMALLY INSULATING ENCLOSURES

(71) Applicant: Victor Mitja HINDERKS, London (GB)

(72) Inventor: Mitja V Hinderks, London (GB)

(21) Appl. No.: 17/803,128

(22) PCT Filed: Aug. 27, 2020
(86) PCT No.: PCT/US2020/048113

§ 371 Date: Feb. 25, 2022

(30) Foreign Application Priority Data
Aug. 30, 2019 (GB) 1912622.6

(51) Int. Cl. F01B 7/14; F02B 75/28; F02B 77/11

(52) U.S. Cl. CPC F01B 7/14; F02B 75/28; F02B 77/11

(57) ABSTRACT

The disclosure describes different types of reciprocating internal combustion engines flexibly mounted in thermally insulating enclosures. A reciprocating component located between two toroidal working volumes in a cylinder is surrounded by an exhaust processing volume, with charge air or gas passing through the interior of the reciprocating component. The enclosures with engines can be “snap-in” mounted into items of equipment needing an engine for operation. In operation, piston extensions or drawbars attached to pistons in operation power crankshafts and/or electrical generators, either rotating or reciprocating. Within an enclosure, air is passed through multiple segregated plenums. Engines having a single piston assembly reciprocating in a cylinder between two combustion chambers are disclosed. Hollow piston assemblies are shown, permitting passage of gas through their interior. Charge air compressors, fuel delivery systems, exhaust emission control systems, electrical generators and exhaust heat energy recovery systems are shown mounted within a single enclosure. Constructional details of pistons transferring power to crankshafts and/or generators via drawbars, as are other construction details.

### TECHNICAL FIELD

The disclosure shows how internal combustion engines can be mounted enclosed within thermally insulating housings or casings and to how the charge air or gas associated with the engines is managed.

### BACKGROUND ART

Today's piston-and-cylinder engine hardware was first commercialized in the mid-18th century, using then available technology. Early internal combustion (IC) engine designers like Gottfried Daimler and Rudolf Diesel adapted the steam expansion chamber to a combined combustion and expansion chamber, leaving hardware essentially unchanged. They added cooling systems to lower the temperatures generated by internal combustion to levels the ferrous components could withstand during the life of the engine. Generally cooling systems dissipate—ie waste 25% to 50% of the fuel energy. A transformed twenty-first century embodiment of the reciprocating IC engine is overdue. The disclosure focuses on improved charge and thermal management in reciprocating engines that are to a degree thermally insulated and optionally do not have conventional air- or liquid-cooling systems.

It is known that efficiency increases with the increase of the temperature differential of the combustion cycle. The hotter the combustion, the greater the efficiency, all other factors being equal. Engine systems are designed to withstand engine performance under peak load which, in most cases occurs for a small percentage of total operating time. At all other times the engine is running colder and therefore less efficiently. Today, almost all engines during most of their operating lifetime run at temperatures substantially below the peak temperatures they are designed for, and so at lower efficiency because of the lower temperature. To improve fuel economy and reduce CO₂ emissions, an important first step would be to maintain engine temperature at all times close to the maximum temperature the engine can withstand, so that at all operating modes it is operating at optimum efficiency.

A second step would be to eliminate conventional cooling systems as far as possible. Such systems typically comprise a water jacket, pump, radiator and fan, or comprise a fan directing air over metal cooling fins or surfaces. The engine can be placed in a thermally insulated enclosure, to establish average combustion temperatures higher than previously possible. Great financial and other advantages accrue by eliminating the cost, mass, bulk, and unreliability of conventional cooling systems. Their failure is the most frequent cause of engine breakdown. In less-cooled or un-cooled engines, the exhaust is much hotter—ie containing a greater portion of the fuel energy—and more work can be derived from it, through some form of exhaust energy recovery system or compounding, for further gains in efficiency. Turbine, steam or Stirling engines may be used to extract work from the hot exhaust gas; as can systems for converting heat directly into electrical energy.

Running at higher temperatures would improve efficiency, since it is dependent on the difference in temperature between ambient air (which is constant) and that at combustion. The resulting hotter exhaust gases will generally be easier to cleanse. Less-cooled or uncooled engines could be thermally, acoustically and vibrationally insulated to virtually any degree, making them more environmentally and socially acceptable. They preferably run at constant-speed and -load. Of the calorific value of the fuel, a greater amount will be spent on pushing a piston, but nearly all the remainder will now be in the hot exhaust gas, where much of it is recoverable. With uncooled engines, average temperatures could be so high that the main piston and cylinder components would likely have to be of special high-temperature metal alloys or of ceramic material.

### SUMMARY OF THE INVENTIONS

The inventions comprise commercial long-life reciprocating internal combustion (IC) engines having reduced or no cooling, mounted in thermally insulating enclosures or casings. Because of the characteristics of most insulating materials, the enclosures will usually function also as acoustic insulation. Principal engine components are generally made of high-temperature alloys and/or of ceramic materials. In selected embodiments an electrical generator is coupled to the engine within the enclosure to form a gen-set. Disclosed are frames linking piston/cylinder assemblies to power take-off devices including crankshafts and reciprocating or rotating electrical generators. The frames and the structures they support are so mounted as to permit independent movement within and relative to the enclosure. A preferred layout comprises a reciprocating component located between two toroidal working volumes in a cylinder surrounded by an exhaust processing volume, with charge air or gas passing through the interior of the reciprocating component. In many embodiments, the number of moving parts per cylinder, and the number of cylinders required for a desired output, are greatly reduced, leading to improved power-to-weight and power-to-bulk ratios. The inventions further comprise using high-temperature and optionally high-pressure exhaust to power another engine, such as a turbine, steam or Stirling engine. New configurations of pistons, cylinders and cylinder heads are disclosed, as are ways of mounting the engine-containing enclosures in items of equipment requiring an IC engine for operation.

### Clarifications

Where charge gas is mentioned, it encompasses air or air mixed with other fluids including fuel, gases other than air including hydrogen, ammonia, hydrogen peroxide, nitric oxide. Fuel as mentioned herein encompasses any liquid or gaseous fuel, including gasoline, diesel, natural gas (CNG), petroleum gas LPG), bio-fuels, fuels derived from waste, ammonia, hydrogen, fuels used for rocket propulsion including such as nitric oxygen, nitrous oxygen and hydrogen peroxide. Features herein described, including fuel delivery systems, materials, exhaust emission processing systems, engine mountings and casings, as well exhaust heat energy recovery systems, are all shown and drawn schematically to no particular scale, to illustrate the principles of the invention. The features can be embodied in any suitable and convenient material. Where diagrams or embodiments are described, these are always by way of example and/or illustration of the principles of the invention. The Figures herein show selected embodiments of the invention and are presented as means of enabling the proper understanding of the inventions, which may be embodied in any appropriate and convenient manner, including those not recited or illustrated here. For example, any type of piston or valve may be used in any engine and the engine portions may be assembled in any manner. The various features and embodiments of the invention may be used in any appropriate combination or arrangement. A feature described in one embodiment or may be incorporated in any other embodiment, even if not specifically described or illustrated in said other embodiment. It is considered that many of the separate features of this complete disclosure comprise independent inventions. Where appropriate, two or more of the separate inventions can be combined, joined or integrated in any manner.

Less-cooled or uncooled engines generally mean engines without a traditional forced-air or circulating fluid system and will hereinafter for convenience be collectively referred to as ‘uncooled engines’. Uncooled engines may have some secondary cooling of either charge (wherein the temperature of the charge is reduced before it enters the combustion chamber) or for cooling of selected engine sub-systems, such as a fuel pump or compressor. The features herein have been described mainly in relation to internal combustion engines, although many are suited to and may be applied to any type of combustion engine, including for example Stirling and steam engines and, where appropriate, to any type of compressor or pump or turbine engine. The word “engine” is used in its widest possible meaning and, where appropriate, is meant to include pump and/or compressor. The disclosures principally relate to pistons reciprocating in cylinders to define fluid working chambers. Generally, the piston has been described as powered by the expansion of fluid to drive some device or mechanism. Wherever appropriate, the piston may equally be driven by some device or mechanism to compress or pump a fluid. The chambers are often referred to as combustion chambers. Wherever the construction disclosed may be applicable to pumps and/or compressors, then the chambers described as for combustion may also be for compression and/or pumping of fluids. Where the terms “working chambers” or fluid working chambers” are used, they refer to chambers which can be combustion chambers, pumping chambers or compression chambers. The word fluid is used herein to mean any appropriate substance, including fuel and charge air or gas. Where the word “fuel” is used in relation to combustion or working chambers, in embodiments or applications where the chambers are not combustion chambers the “fuel” can be any suitable fluid. The term “partial vacuum” means any degree of vacuum, since a perfect vacuum is not realistically obtainable in the embodiments disclosed herein. In the embodiments described by way of example, components have variously been described as attached together, bolted together, bonded together, fused together. The different elements and components of the invention may be attached to one another or fastened together by any convenient or appropriate means, including those referred to in the description of embodiments. Generally in this disclosure, like numbered parts have similar characteristics and/or functions. All the diagrams are for purposes of illustrating the features of the invention and are schematic. The components are shown at no particular scale relative to one another. Where the phrase “as disclosed herein” is used, it means as disclosed anywhere in this entire patent-related document, including all of the text, the claims, and all the Figures.

In the following text and recital of claims, “filamentary material”, where disposed in a housing or container of some kind, is defined as portions of interconnected or abutting or closely spaced material which allow the passage of fluid therethrough and induce turbulence and mixing by changing the directions of travel of portions of fluid relative to each other. By interconnected or abutting or closely spaced is meant not only integral or continuous, but also intermittent, intermeshing or inter-fitting, while not necessarily touching. The above definition is applied both to material within a housing or container as a whole, and also to portions of that material in any fluid processing volume, or portions of such volume. By “ceramic” is meant baked, fired or pressed non-metallic material that is generally mineral, ie ceramic in the widest sense, encompassing materials such as glass, glass ceramic, shrunken or re-crystallized glass or ceramic, etc., and refers to the base or matrix material, irrespective of whether other materials are present as additives or reinforcement. By “elastomeric”, “compressible”, “elastic”, “variable volume”, “flexible”, “bending” and all other expressions indicating dimensional change is meant a measurable change that is designed for and is understood to happen during an operating cycle, not a relatively small dimensional change caused by temperature variation or the imposition of loads on solid or structural bodies. By “electric motor/generator” is meant an electrical device which can be either a motor or a generator, or a device which can function as both at different times. “Stoichiometric”, where used in reference to air or gas/fuel mixtures in combustion engines, is used as is common in engineering language, and can indicate that quantity of fuel whose carbon will combine with all the oxygen in the charge under ideal conditions, leaving neither carbon nor oxygen in the exhaust. Where reference is made to an item being “mounted about” a second item, this is intended to mean that the first item can be physically associated with the second item in any way, including mounted in, mounted on, attached to, and connected to the second item, including by some intermediary means, such a strut. The word “vehicle” is meant to include every kind of surface vehicle, including motor cycles, three-wheelers, passenger cars, trucks of every size, buses, mining and industrial vehicles of every kind, railed vehicles, tracked vehicles such as tanks, and un-manned vehicles of any kind. The word “computer” denotes any assembly of physical items which, when provided with electrical power, is capable of processing data. A computer program is any set of instructions that enable data to be processed in a certain manner. In the following text, abbreviations are used, including: rpm and rps for “revolutions per minute” and “revolutions per second” respectively, BDC/TDC for “bottom dead center/top dead center”.

### BRIEF DESCRIPTION OF THE DRAWINGS

FIGS. 1 to 6 show schematically IC engines movably mounted in enclosures.

FIG. 7 shows an alternative piston to crankshaft linkage.

FIGS. 8 and 9 show multiple piston/cylinder assemblies linked to one or more crankshafts.

FIGS. 10 to 13 show enclosures housed in vehicles.

FIGS. 14 and 15 show tongues projecting from the ends of a piston extension.

FIG. 16 shows multiple charge gas flows within an enclosure.

FIG. 17 shows a tubular frame linking piston/cylinder assembly to a crankshaft.

FIGS. 18 to 20 show details of the drawbar arrangement of FIG. 17.

FIGS. 21 and 22 show a way of connecting cylinder portions to each other.

### DESCRIPTION OF THE INVENTIONS

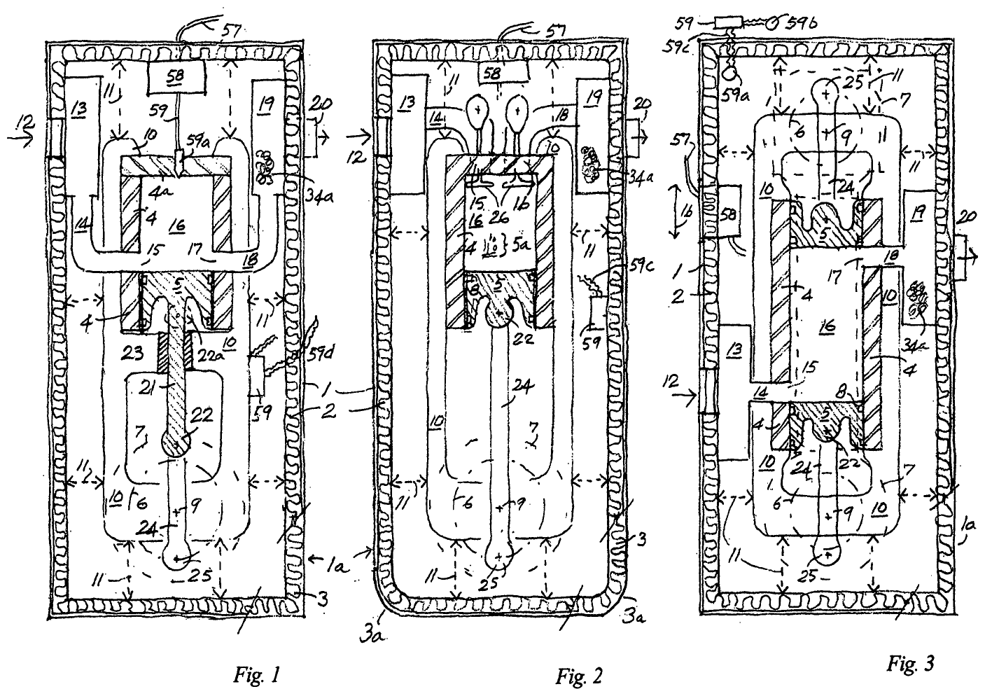

FIGS. 1 to 6 show various types of IC engine that can be adapted to be mounted in a thermally insulating enclosure. Like components have the same numbers, not indicated on every of the similar components. All the enclosures la are similar, having an external skin optionally of metal 1 lined interiorly with insulating material 2. As an alternative they might be of an integral material having insulating properties as indicated in the bottom right corner at 3, including such as used for industrial applications or heat resistant kitchen counter tops, as for example Corian. A cylinder assembly 4 usually has a cylinder head portion 4a, with at least one piston assembly 5 reciprocatable within the cylinder. In most embodiments the piston assembly is connected to a crankshaft rotatable about axis 9 indicated only schematically by a chain dotted line 6 describing the path of a big end bearing 25. Optionally a combined generator/starter motor indicated schematically by dashed line 7 is mounted co-axially with the crankshaft, either one at one end of or two one at each end of the crankshaft Optionally the generator/starter motor(s) are located in any position and are driven by the crankshaft directly or indirectly by any means. Optional piston rings 8 are provided either on the piston and/or in the cylinder assembly. The piston rings can be a continuous closed ring, a ring with a small expansion/contraction gap or slit or be comprised of abutting multiple segments. The rings may have any cross-section, including having the surface adjacent the piston/cylinder gap at an angle to the direction of reciprocation. The piston/cylinder assembly is supported by any bearing(s), including sleeve bearings 23 and/or roller bearings 28. Piston/cylinder assembly, bearings and a power out device such as a crankshaft and/or generator are rigidly attached to a common flame or frame system/structure 10. This frame 10 is directly or indirectly flexibly mounted within the enclosure to permit movement separate and independent of the enclosure by any convenient means indicated by dashed double arrows 11. The means could be of any number or orientation, including of greater or lesser number than illustrated, and could comprise springs, dampers, or any other compressible and expansible product or material. The enclosure has at least one grille 12 for entry of charge gas, the grille or area behind optionally including any embodiment of one or more filters (not shown). The grille and entry supplies charge gas, optionally to any type of charge compressor 13 from which compressed charge is directed to intake port 15 via passage 14. Exhaust leaves the combustion chamber 16 via port 17 and navels via passage 18 to an exhaust emissions treatment system 19, to exit via opening 20. All the enclosures la have an external fuel-in connection 57 linked to a fuel delivery system 58 mounted anywhere within the enclosure, or optionally on the frame 10. The fuel delivery system includes an optional fuel lift pump and a high-pressure pump for distribution of fuel to combustion chamber(s). From the fuel delivery system one or more lines 59 lead to a device 59a, optionally a fuel injector, supplying fuel to the combustion chamber 16 or 39. For the sake of pictorial clarity, device 59a is only shown in FIG. 1 and is not shown in FIGS. 2 to 6, although it is an essential part of all the engines of the invention. The enclosure la optionally has removable panels indicated selectively and schematically by adjacent arrow 1b, for purpose of accessing electrical generators and/or subsystems such as fuel delivery systems; filters; charge compressors; exhaust emissions treatment systems; exhaust heat energy recovery systems; etc. Optionally, a computer 59 is provided fir any of the engines of the invention, located either outside of or within enclosure 1a, with electrical or other connection to at lead one sensor 59a placed anywhere within the enclosure. In all the engine embodiments, the computer is optionally linked by any means to a sensor 59b measuring at least the ambient air temperature which is placed adjacent to grille 12 or in any location outside the enclosure la Optionally the computer is linked by connection 59d to a control panel or display (not shown) located anywhere, including on the exterior surface of the enclosure 1a. The enclosures are shown with rectangular corners. In alternative embodiments they have rounded or spherical corners, as shown by way of example at 3a in FIG. 2. In FIGS. 1 to 6, the exhaust gas processing volumes 34 and/or the emissions treatment systems 19 optionally contain filamentary material 34a for purpose of breaking up unidirectional gas flows and improving the inter-mixing of individual pockets of gas. Optionally at least portion of the filamentary material has a catalytic effect. Filamentary material is more fully described in my published PCT, WO 2009145745A.1. In the embodiments illustrated there is a single piston/cylinder assembly driving a power output device such a crankshaft or electrical generator mounted within one enclosure. In alternative embodiments, multiple piston/cylinder assemblies powering a single output device or multiple output devices can be mounted within a single enclosure.

In engines of no or reduced cooling, average temperatures in the combustion chambers considering the whole cycle could be as high as 800° C. to 1,200° C. It is probable that liquids cannot be used to separate piston and cylinder in an uncooled engine; today's conventional oils would quickly boil away. One alternative is to use a gas bearing (known technology but so far not used in piston IC engines) which uses a film of gas to separate components. Such a film of gas is already present in in nearly all of today's engines in the form of blow-by, a tube-shaped gas flow from a high-pressure zone in the combustion chamber, past the piston and piston rings, to a low-pressure zone, usually the crankcase volume. In most embodiments having a conventional crank/conrod layout, the gas flow will not prevent the piston impacting the cylinder during the sizable twisting and side loads imparted to the piston when the crank is around 90° and 270° of rotation. The combustion chamber surfaces optionally include small depressions or grooves to effect a slowing down of the blow-by gases, using any established techniques including labyrinth sealing. They are shown schematically at 5a only in FIG. 2 but can be incorporated in any of the combustion chamber surfaces of the engines of the invention. In many embodiments, such side loads have to be taken up outside the piston/cylinder assembly by means including doubled conrods, rollers or sleeve bearings, and other devices as outlined herein.

By way of example, FIG. 1 shows a two-stroke engine, having a cylinder head 4a not integral with the cylinder 4 (as it is in FIGS. 2 and 4 to 6), but separate, as in most engines today. Such an arrangement could be considered for lightly stressed engines. Generally, the much higher combustion chamber pressures and temperatures of uncooled engines will make the provision of a long-life cylinder head gasket difficult In this embodiment the “double con-rod” linkage of some large marine engines is used. The first ‘conrod’ is a rigid extension 21 of the piston 5 slidably mounted in one or more sleeve bearings 23 terminating in bearing 22, to which the second ‘real’ conrod 24 linked, its other end terminating in big end bearing 25 mounted on the crankshaft. In an alternative embodiment, the piston extension 21 is attached to the piston 5 by a bearing 22a. The ports 15 and 17 are shown opposite each other, in an alternative embodiment not shown one of the ports may be in the head 4a closable by a poppet valve 26, as shown in FIG. 2.

In another example, FIG. 2 shows a layout adaptable both as a two-stroke and as a four-stroke engine, wherein both ports are in the head and are closable by poppet valves 26 actuated by camshafts 27. It shows a piston to crank linkage suitable for less stressed engines wherein either piston sideloads are so small that some kind of gas bearing can be used, or where a liquid or solid lubricant between piston and cylinder can be applied. It has a conventional single conrod 24, longer than normal to minimise piston side thrust.

In a further example, FIG. 3 shows a two-stroke engine having two pistons 5 in a single cylinder 4 working on a single combustion chamber 16, each piston driving a dedicated crankshaft via a conventional single conrod, each crankshaft driving a co-axial rotating generator 7 outline by dashed lines. Although shown relatively short, the conrod can be of any length. In an alternative embodiment, each crankshaft can be driven using the double conrod configuration shown in FIG. 1. The crankshafts are optionally connected, via a linkage not shown. In other embodiments not shown, the pistons can drive one or two reciprocating generators, at least one which can optionally also function as a starter motor.

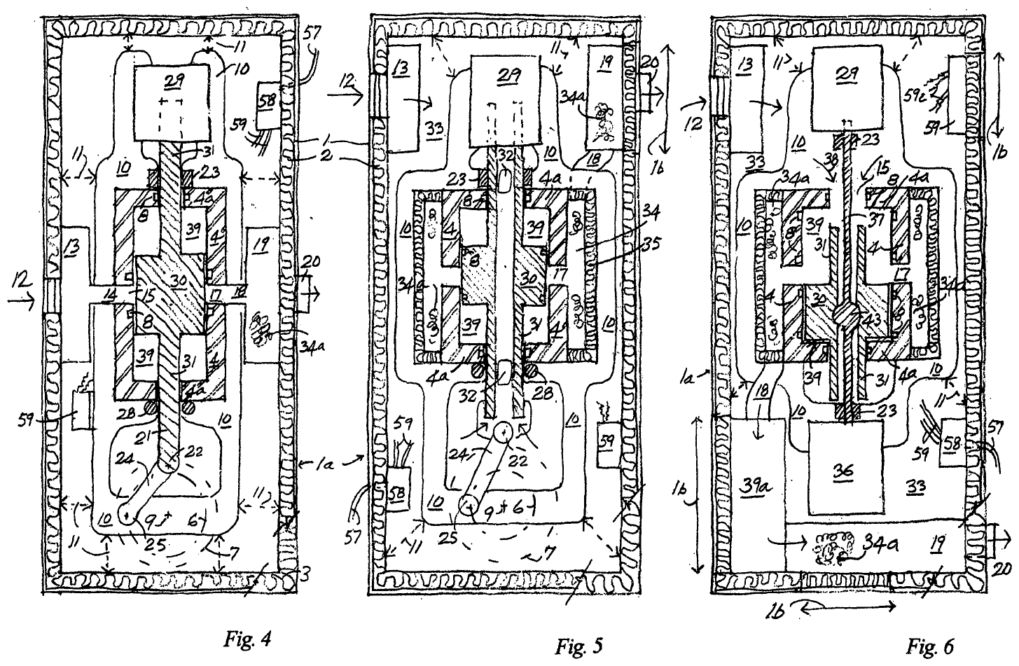

By way of examples, FIGS. 4 to 6 show a single piston assembly separating two combustion chambers at each end of a single cylinder assembly, the piston assembly comprising a central piston portion 30 having extensions 31 capable of penetrating the head 4a, optionally driving a rotating or reciprocating generator. The combustion chambers 39 are of toroidal configuration during at least part of the operating cycle. FIG. 4 shows a two-stroke with central opposed ports. The piston extensions are mounted in sleeve bearings 23 and/or between roller bearings 28 to guide the piston assembly and prevent it making contact with the cylinder walls, in those applications where an optional liquid or solid lubricant between piston and cylinder is not used. The lower portion of the diagram shows a double conrod linkage driving a crankshaft driving an optional rotating generator in an arrangement similar to that of FIG. 1. The upper portion shows an alternative power take-off option wherein the piston extension drives a reciprocating electrical generator 29.

FIG. 5 shows a two-stroke engine having a piston assembly with a central passage for gas flow, broadly co-axial with direction of reciprocation, with the piston extensions having ports, here for charge gas entry. The compressor discharges pressurized gas into at least portion of the interior of the enclosure to for a plenum 33 of higher-pressure charge gas. When both ports are open, the pressurized charge will flow from the plenum 33 through the ports 32 to displace the exhaust gas via port 17 into a circumferential exhaust gas processing volume 34 enclosed by thermal insulation 35. The exhaust the flows via passage 18 to the emissions treatment system 19 to exit 20. Again, the lower portion of the diagram shows a double conrod linkage driving a crankshaft driving an optional rotating generator in an arrangement similar to that of FIG. 1, with the upper portion showing an optional alternative power takeoff wherein the piston extension drives a reciprocating electrical generator 29. Optionally, a circumferential exhaust gas processing volume 34 enclosed by thermal insulation 35 surrounding at least portion of the cylinder assembly can be incorporated in any embodiment of the invention, including those of FIGS. 1 to 4.

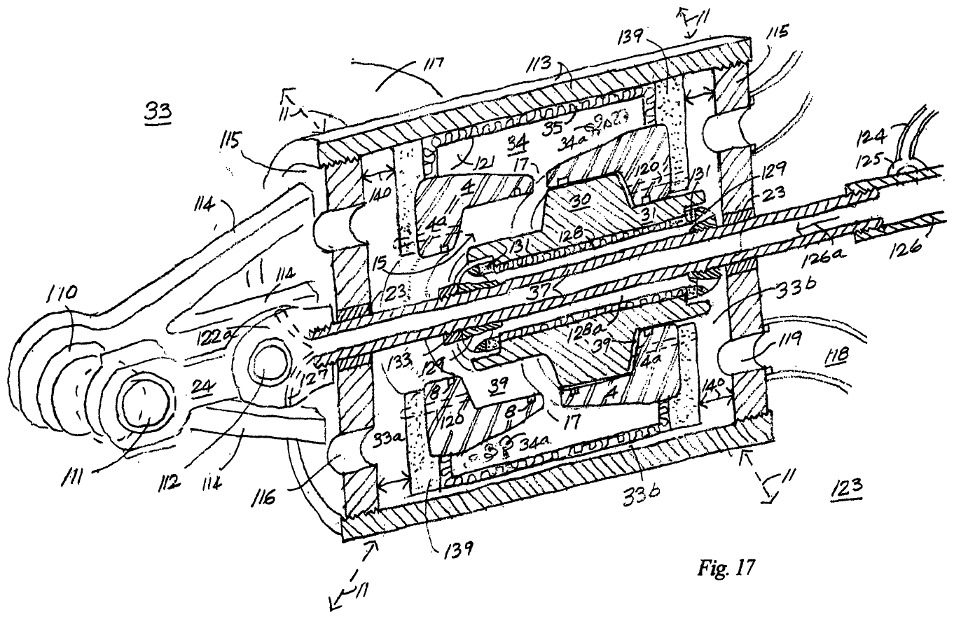

FIG. 6 shows a piston/cylinder assembly broadly similar to that of FIG. 5, but here the piston assembly is caused to both rotate and reciprocate relative to the cylinder assembly by any appropriate mechanism 36, including such as are described in my published PCT application WO2009 145745A.1. Loads from the piston assembly are transferred by a connection 43 of any configuration to a drawbar 37, which in turn transmits loads to a reciprocating electrical generator 29. The compressor discharges pressurized gas into at least portion of the interior of the enclosure to form a plenum 33 of higher-pas rue charge pi. The piston extensions 31 are shortened so that at BDC or TDC the gap between the top of the extension and the underside of the head acts as an intake port 15 to, with charge gas 38 flowing from the plenum through it into the combustion chamber 39, which is of toroidal form during part of the operating cycle. In the lower half of the diagram an exhaust heat energy recovery system (EHERS) 39a of any appropriate design or configuration is mounted within the enclosure 1a. Exhaust gas travels to it from processing volume 34 via passage 18 and leaves it via emissions treatment system 19 to exit at 20. Optionally, the relative positions of EHERS 39a and emissions treatment system 19 can be reversed. Optionally the EHERS includes another engine such as a turbine, steam or Stirling engine, effectively making the enclosure and its contents into a compound-engine genset. In alternative embodiments the EHERS is located outside enclosure, with the emissions treatment system inside the enclosure or outside it, optionally near to the EHERS. FIGS. 1 to 6 show electrical generators coupled to engines with both mounted within enclosures. In alternative embodiments, the generators are mounted outside the enclosures and driven by shafts, as shown by way of example in FIGS. 12 and 13, or by some kind of piston extension penetrating the enclosure (not shown).

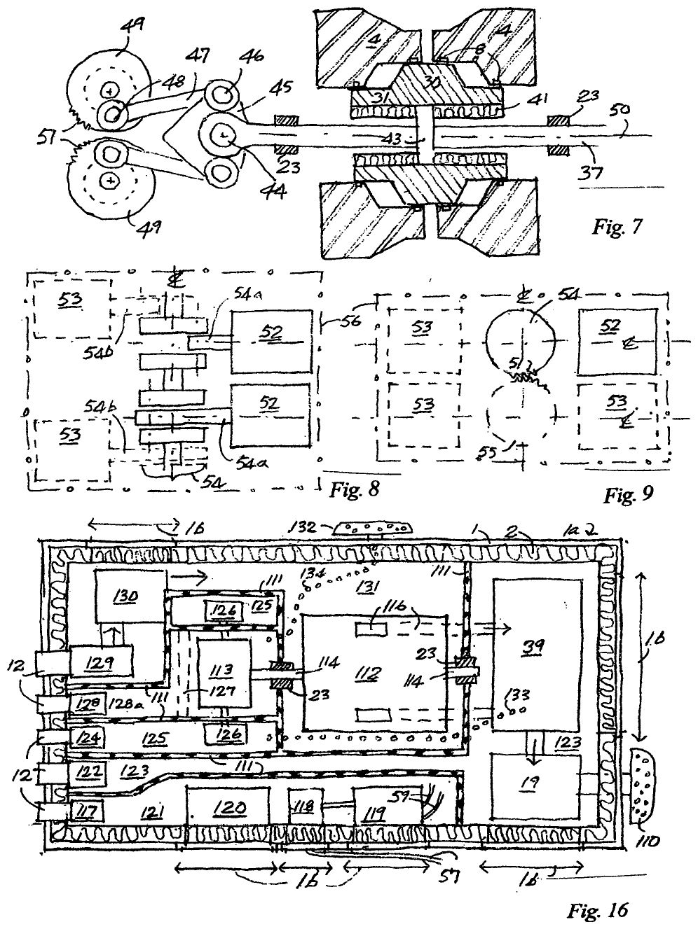

Another way of virtually eliminating side loads on the piston is having a single piston powering two optionally contra-rotating crankshafts, as shown by way of example schematically in the layout of FIG. 7, drawn to no particular scale. The hollow piston 30 with extensions 31 of heat-tolerant material reciprocates along axis 50 in the two-part cylinder assembly 4 between two toroidal combustion chambers 39, with the interior of the piston lined with insulation 41. A draw bar 37 attached to the carter of the piston assembly by any convenient mechanism 43 is supported by sleeve bearings 23. The drawbar 37 terminates in a special bearing 44 linked to a load distributor plate 45, in turn connected by small end bearings 46 to conrods 47 in turn connected to big end bearings 48 to crankshafts 49. The crankshafts can rotate independently, or they could be linked by any convenient mechanism, including by gear teeth as shown schematically at 51. Optional piston rings are provided at 8. For the sake of pictorial clarity, the flame linking the piston/cylinder assembly to the sleeve bearings and the crankshaft is not shown. FIG. 7 shows the piston/cylinder assembly of FIG. 6, but any piston/cylinder assembly can be so connected to twin crankshafts.

In further embodiments, multiple cylinder/piston assemblies drive one or more crankshafts. The crankshafts could each have multiple throws connected to multiple piston/cylinder assemblies, each either having one or two combustion chambers, as noted above. FIG. 8, a plan view, and FIG. 9, an elevational view, show schematically by way of example a crankshaft assembly 54 with two throws 54a, connected to two piston/cylinder assemblies shown in outline at 52, optionally each with two combustion chambers. In another embodiment the crankshaft could have two additional throws 54b in a position connecting with a second pair of piston/cylinder assemblies shown in dashed outline at 53, to provide a ‘boxer’ type layout, optionally with a total of eight combustion chambers, all mounted within a single thermally insulating enclosure, indicated schematically by chain-dashed lines at 56. In an alternative embodiment, a second crankshaft assembly 55 is placed beneath the first assembly 54 and optionally linked to it by gearing 51 or any other convenient means. The second assembly 54 can have multiple throws connected to two or flair piston/cylinder assemblies shown dashed at 53, with both crankshaft assemblies and all piston/cylinder assemblies within one thermally insulating enclosure 56.

Because the enclosure is thermally insulated and the engine inside is ‘uncooled’, in most embodiments there will not be a conventional cooling system with associated fan and cooling fins exposed to ambient air, nor a radiator circulating fluid from an engine block. The absence of these items and their associated plumbing means that the enclosure and the engine within could together be configured as a “snap-in” can ridge, quickly installed and removed from a piece of equipment requiring an engine for operation, perhaps in minutes. Items of equipment that could use such a cartridge include vehicles railed vehicle marine craft of all sizes; aircraft; agricultural, industrial and mining equipment.

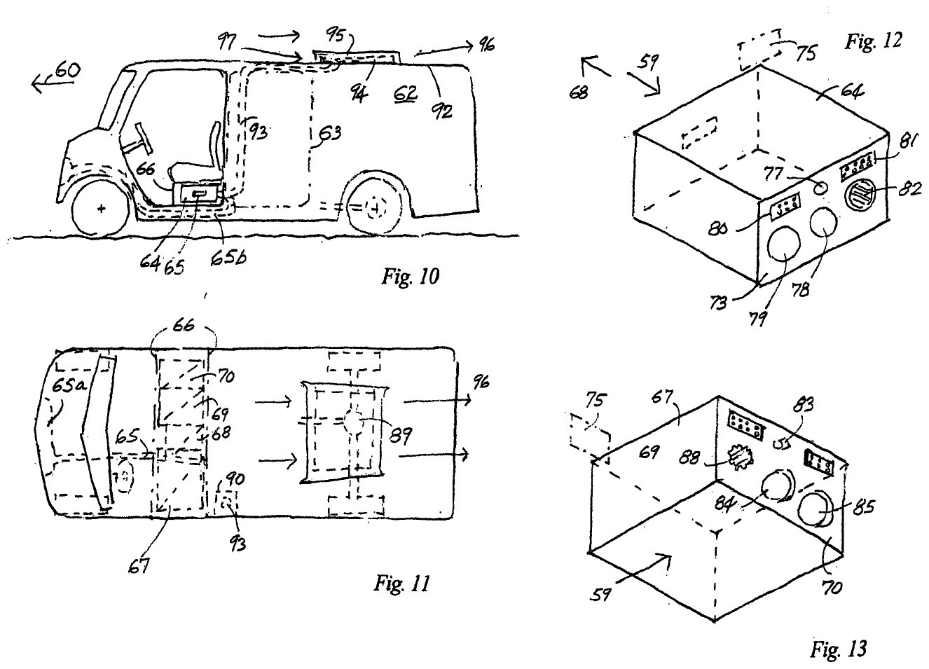

By way of example, FIGS. 10 through 13 show schematically an inner-city small parcels delivery truck having a drive including the enclosure with engine of the invention, where FIG. 10 is an elevational view, FIG. 11 is a plan view, and FIGS. 12 and 13 are details of engine connections. Direction of normal vehicle movement is indicated at 60. Only the teatimes relating to the invention will be numbered and described, not the typical features of the truck. The truck 62 is shown with driver's sliding door recessed in the open position shown dashed at 63, exposing the engine enclosure 64 with recessed drawer-style pull handle 65 located under the driver's seat. A bulkhead 66 which has the female recess 67 into which the engine casing is fitted extends all the way across the vehicle, and within it accommodates a connection zone 68, a transmission 69, and a spare for ancillary equipment 70, such as air conditioning system, etc., all indicated separately by dashed diagonal lines. FIG. 12 shows the exterior of the engine enclosure 64 having side 71, top 72 and rear plate 73. FIG. 13 shows the recess 67 in the vehicle bulkhead 66 into which the enclosure 64 is installed in direction 59 and removed in direction 68, having side plate 69 and backplate 70. To assist visualization, plane 75 in FIGS. 12 and 13, shown chain-dashed, indicates a plane parallel to and co-incident with the side of the vehicle 62, the rear of the recess 67 and the front of the enclosure 1a. The rear plate 73 of the enclosure 64 has female openings for fuel 77, intake gas 78 and exhaust gas 79, male electric 80 and electronic 81 connectors, and the end of a rotatable hollow output shaft 82 having female splines. The recess 67 has a vertical backplate 70 having conically shaped stub tubes for fuel 83, for intake gas 84 and exhaust gas 85, female electric 86 and electronic 87 connectors, and the end of a splined rotatable shaft 88 which passes through the connection zone 68 to drive the transmission 69, from where power is transferred to rear wheels via drive shaft, differential 89 and rear axle. Air intake is via plenum 65a and passage 65b leading to recess 67. Exhaust gas travels via optionally thermally insulated enclosure 90, up optionally insulated riser pipe 93 across underside of roof 92 to a large flat muffler shown dashed at 94 located between roof and shallow roof-mounted housing or projection 95. Exhaust exits at root away from vehicle sides and distant from vehicle rear, in direction 96. Optionally, both muffler 94 and housing 95 are so designed that when the vehicle is in motion airflow at 97 creates a venturi effect to extract exhaust gas and reduce engine back-pressure, so improving fuel economy.

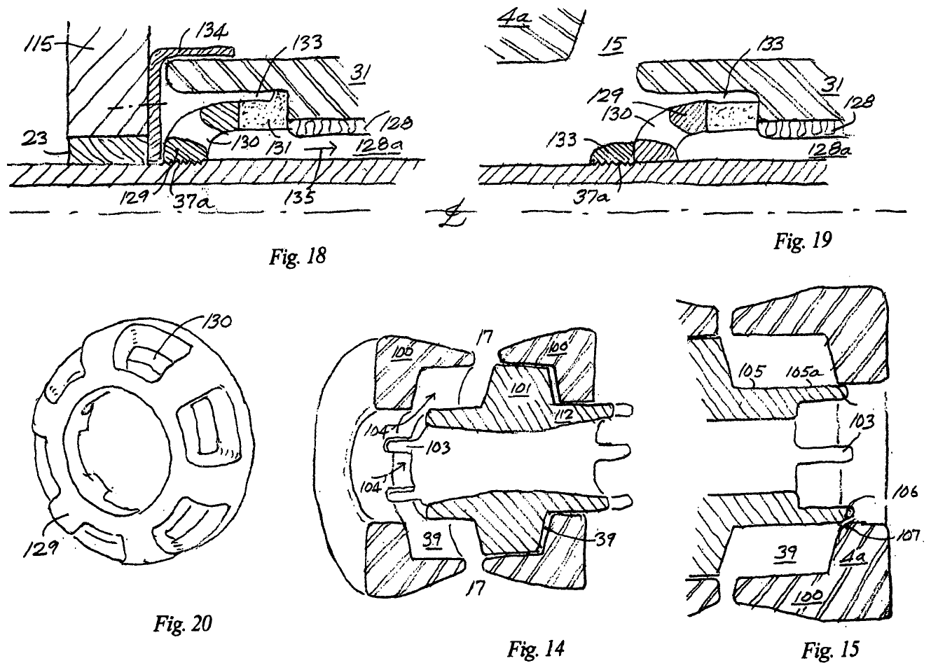

In some of the embodiments, as for example that of FIG. 6, the piston with its extensions pierce the cylinder head at TDC/BDC while at the other end the piston extension is clear of the head, the gap permitting charge gas to enter the combustion chamber. As the piston moves from one end of reciprocation, there is a chance—when there is a slight mis-alignment—of the lip of the extension hitting the head. To mitigate that, the lip of the piston extension 31 is provided with one or multiple projecting tongues which never clear the head and act as guides, with charge gas flowing between the gaps between the tongues, as illustrated schematically in FIG. 14, drawn to no particular scale. Two halves 100 of the cylinder (the structure or frame connecting them is not shown) are assembled about the piston 101 shown at BDC, where the lips of piston extensions 102 have projecting tongues 103 which never entirely clear the head. Charge gas flows as shown by armors 104 between the tongues 103 into the combustion chamber 39, of toroidal configuration during at least part of the operating cycle, with the exhaust port(s) shown at 17. For the sake of pictorial clarity, the drawbar to transfer power out and it connection to the piston assembly are not shown. FIG. 15 shows the tongues schematically 103 when the piston is at TDC, with the exterior surface of the tongue in one embodiment shown at 105a aligning with the exterior surface 105 of the piston extension. In another embodiment, shown at exaggeratedly at 106, the exterior surface of the tongue is slightly chamfered in relation to the exterior surface of the piston extension, enabling the piston to properly align itself as it enters the head portion 107 of the cylinder assembly. Additionally or alternatively, portion of the opening in the head portion 4a might be chamfered, as shown exaggeratedly at 107. Again, for the sake of clarity, a drawbar or other means of transferring work to a power take-off mechanism is not shown.

In ideal circumstances, all the engine parasitic losses that are expressed as heat are retained by passing charge gas over the sources, such as bearings, electrical generators, oil pumps, fuel lift pumps, fuel high-pressure pumps, and charge gas compression devices. In some embodiments, especially those with high compression ratios, the sum of the heat that represents the parasitic losses plus the heat generated by combustion may raise average temperatures to a level higher than the piston/cylinder materials can withstand for the planned engine life, and/or so high that unacceptable levels of NOx are generated. Lowering the compression ratio will permit more of the parasitic losses' heat to be taken up/absorbed by the charge gas. To prevent all of the parasitic losses being absorbed by the charge gas, the interior of the casing can be divided into separate gas-flow zones or plenums. In one embodiment, the charge gas goes directly into the combustion chamber, without out being passed over any other heat sources. In another embodiment, if there is a charge gas compression device and it is not cooled by a separate gas flow, the compression device's parasitic losses expressed as heat can be transferred to the compressed charge. The charge gas will therefore become hotter for two reasons: a) it has been compressed and b) it has absorbed the waste heat from the device. Charge gas that been heated by sub-systems' parasitic losses can, as noted, be i) wholly or partly directed to the combustion chamber or ii) it can be discharged to ambient air, or iii) it could be directed to the exhaust heat energy recovery system, to cool the exhaust gas or for any other purpose. In many embodiments one or more of the foregoing three alternatives will be incorporated.

FIG. 16 shows by way of example a schematic sectional plan view, drawn to no particular scale, of an enclosure 1a optionally comprising an outer structural layer 1 and an inner layer of thermal insulation 2, having grilles 12 for admitting ambient air and/charge gas, optionally with filters behind (not shown) and removable access panels 1a for access to sub-systems. A fuel line in is shown at 57; it could enter the enclosure at any convenient location. Exhaust gas leaves the enclosure la via an optional exhaust gas diffuser 110 of any convenient configuration and construction. Within the enclosure various volumes of gas at differing temperatures and pressure are separated by barriers 111 indicated by a double line filled with dashes. A cylinder/piston assembly 112 drives a crankshaft/power take-off assembly 113 via a drawbar 114 mounted in sleeve bearings 23. In one embodiment the barriers 111 run up against the structures or frame (not shown) supporting the sleeve bearings. Exhaust leaves the piston/cylinder assembly via passages partly at high level 116 to be fed into an exhaust gas heat energy recovery system (EHERS) 39, from where it goes to exhaust emissions control system 19, and then exits the casing via diffuser 110. In alternative embodiments (not shown), the exhaust gas first goes to the emissions processing system and from there to the exhaust heat energy recovery system and then to ambient air via the diffuser. In another alternative embodiment not shown the diffuser may be substantially within the casing or may be housed in an exterior recess in the enclosure. Ambient air or charge gas is supplied via fan or impeller or compressor 117 to a volume or plenum 121 containing a fuel lift pump 118, a fuel high-pressure pump 119 and an electronic control/monitoring complex 120, optionally including a computer (not shown). In an alternative embodiment one or more of items 118, 119, 120 are housed in separate plenums, each supplied with gas via its own fan, impeller or compressor. Fan or impeller or compressor 122 provides cooling gas to the plenum 123 containing the two exhaust systems 39 and 19, while fan or impeller or compressor 124 provides cooling gas to plenums 125 each containing an electric generator/starter motor 126 driven by each end of a crankshaft/power take-off assembly 113, with their enclosures linked to each other by overhead or underneath passage 127. In another embodiment, if the electric generator(s)/starter motor(s) are air cooled, each may have its own adjacent or integral fan. In alternative embodiment not shown there is only one generator/starter motor linked to one end of the crankshaft assembly. In another embodiment not shown there is no crankshaft assembly and the drawbar 114 drives a reciprocating generator/starter motor. Fan or impeller or compressor 128 provides cooling air to plenum 128a housing the crankshaft/power take off assembly 113. Grille 12 admits charge gas, optionally through a filter (not shown) for the combustion chamber(s), which is optionally provided by a fan or compression device 129, from where it may go to an optional intercooling device 130 before being directed to plenum 131 from which the charge is admitted to the combustion chamber(s)—not shown—within the piston/cylinder assemblies. The heated gas from some or all of the plenums is directed via passages to the exhaust gas heat energy recovery system 39, as shown schematically for plenum 125 in one example by circles line 133, to dilute and reduce the temperature of the exhaust gas that it is processing. Additionally, some or all of the heated gas from the plenums is discharged outside the enclosure via another gas diffuser 132 via passage 134 indicated by circles line, as shown schematically for plenum 128a optional access panels are indicated at 1b. FIG. 16 is an example. The piston/cylinder assembly, the crankshaft assembly, electric generator(s) or the reciprocating generator, as well as the various subsystems can be arranged in any convenient position and relationship in the enclosure. Separate plenums have been shown for the majority of the components. In other embodiments, they can be combined and separated in any way. The ambient air or charge gas intakes have all been shown in one side of the enclosure, a convenient arrangement should the enclosure with engine be a snap-in unit, but the intakes can be provided in any part of the enclosure.

There are many possible ways of connecting a conrod or drawbar to the piston. One such is shown schematically in FIG. 17, not drawn to any particular scale. It shows a cylinder assembly consisting of two parts (connecting linkage not shown), each having a cylinder portion 4 and an integral head portion 4a, enclosing a piston assembly. The piston assembly is similar to that of FIG. 6, having a piston portion 30 with fixed extensions 31 which penetrate the head 4a during portion of the operating cycle. Loads are transferred from the piston assembly via an attached drawbar 37 which is linked to a crankshaft 110 via a conrod 24 having big end bearing 111 and small end bearing 112. The drawbar is optionally hollow to provide a passage for cooling gas. In uncooled engines, the average temperature throughout the operating cycle of the principal piston/cylinder components 4, 4a, 30 and 31 is likely to be in the 800° C. to 1,200° C. range. In this embodiment the frame linking the cylinder portions to the crankshaft comprises a cylinder or tube 113 into which locator endplates 115 are attached, optionally by being threaded into the interior of the tube ends. At least one secondary structural frame 114 is attached to an and locator plate. The tube 113 and secondary frame 114 are of any suitable material including high-strength metals or metal alloys. The locator end plates 115 support the sleeve bearings 23 which align the piston assembly in the cylinder assembly. At least the tubular portion of the flame system is directly or indirectly attached to the enclosure by flexible and/or compressible mountings 11, to permit the frame system to move independently of the enclosure.

Optional piston rings are shown at 8. Above the head portions of the cylinder are relatively incompressible thermally insulting plates 139, preferably made of a ceramic material such as zirconia, with a fuel delivery device 120, such as an injector, housed in head 4a. Only two are indicated for each combustion chamber, but it could have more. Because the chamber is of toroidal farm, the best and quickest fuel delivery would be accomplished if optionally multiple fuel delivery devices were provided for each combustion chamber. Incompressible structural spacer elements of any material, configuration and composition are indicated by arrows 140 and save to separate the locator plates 115 from the insulating plates 139. In an alternative embodiment the spacers 140 am compressible elements of any kind, including such as springs. Where them is no crankshaft and the piston assembly is connected to a reciprocating generator, the springs optionally function as a stroke lengthener, increasing compression ratio with increasing engine speed. The piston 30 reciprocates in the two-part cylinder 4 (the structure connecting the halves not are not shown). When the piston assembly is at or near BDC, the gap between the end of the piston extension 31 and the underside of the head 4a forms the intake port 15, painting gas to flow into the combustion chamber 39. At the same time, exhaust port(s) at 17 are exposed to allow exhaust gas to flow into to a circumferential exhaust processing volume 29 enclosed by insulation 30 and optionally containing filamentary material 34a. In an alternative embodiment, shown in the lower half of the diagram, the insulation is spaced from the interior of the tube wall by any means to permit gas to circulate between the end plates. If the assembly shown is located in a plenum 33 containing compressed charge, as indicated schematically in FIGS. 5 and 6, compressed charge gas will flow through holes 116 in the locator plates 115 into the secondary plenum 33a and from there flow into the combustion chambers 39 via the intake polls 15 when the ports are open. In an alternative embodiment, illustrated at the right-hand end locater plate 117, the piston/cylinder assembly is in another plenum 123 which does net contain compressed charge. Instead compressed charge is provided via passages 118 and holes 119 in end plate 117 to create a separate plenum 33b limited to the space between the end locator plates. Exhaust leaves the exhaust processing volume 34 by at least one aperture 121 communicating with a passage 117a leading either an EHERS or in an exhaust emissions treatment system. The flaming structure 113 and 115 is directly or indirectly mounted within the enclosure (not shown) by flexible and/compressible means indicated schematically at 11, to permit movement relative to the enclosure. The drawbar comprises a metal tube 37 of any suitable material, including titanium and nickel-chrome alloys, screw-threaded into the small end bearing support structure 122a, while the other aid is optionally screw-threaded into the reciprocation portion of an electrical generator 126. Optionally drawbar 37 is hollow and the interior of the drawbar is cooled by gas pumped in, shown here by way of example via supply 124 and connector 125 to flow in direction 126a and exit via passages 127 in the small end bearing 112 housing 122a. Optionally, the interior of the piston assembly 30 and 31 is lined with insulating material 128.

One embodiment of a connection between piston and drawbar is described more fully in enlarged detail FIGS. 18 to 20. The drawbar 37 has a threaded portions 37a onto which end pieces are mounted. By way of example one such end piece is a structural colander 129 as illustrated schematically in FIG. 20 attached to the drawbar as shown in greater detail in FIGS. 18 and 19. The colander is of any suitable material, including that of the drawbar. The colander 129 has apertures 130 permitting the flow of gas to and from the volume 128a between the drawbar 37 and insulation 128 and is attached to a threaded zone 37a on the drawbar. The colander is mounted on a collar 131 of high temperature rigid insulating material, such as ceramic. In FIG. 18 the collar 131 has a toe for accurate location in a recess in the piston extension 31, permitting the greater part of the collar to be clear of the piston extension to forth an gas gap 133. In an alternative embodiment shown in FIG. 19, the collar 131 has no toe. In another alternative embodiment, the end piece such as the colander is not threaded on to the drawbar, instead a nut 133 is threaded onto the drawbar to retain the end piece/colander in position. Optionally, a cup-shaped shroud 134 of any suitable material is attached to the locator plate 115 and/or sleeve bearing its internal diameter just fractionally larger than the external diameter of the piston extension 31. During path of the piston assembly towards TDC/BDC, it will enter the lip of the shroud to compress the gas therein and push it through the apertures 130 in the structural colander 129 and cause it to flow through the cylindrically shaped gap or passage 128a between the exterior of the drawbar and insulation 128 in direction 135. In a preferred embodiment there is a shroud at only one side of the drawbar, to effect gas movement consistently in one direction. In another embodiment, there are two shrouds, one on each locator plate. In a further embodiment, means other than screw threading are used to attach colander 129 and/or nut 133 to the drawbar.

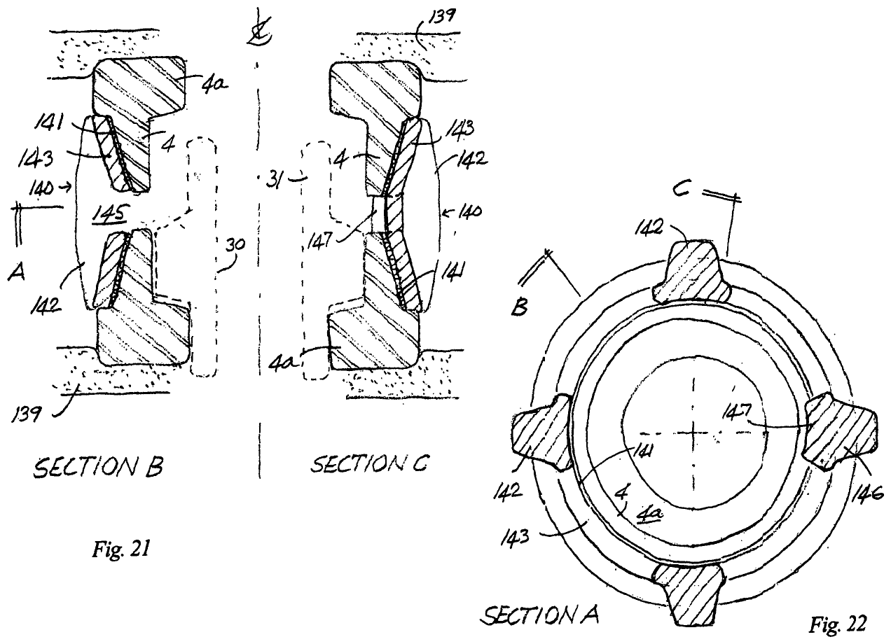

To build some of the engines of the invention, the two parts of the cylinder must be assembled around the piston and be properly aligned. FIGS. 21 and 22 show by way of example one way of accomplishing this. FIG. 21 shows vertical sections through the cylinder assembly taken at B and C, while FIG. 22 is a horizontal section through the cylinder taken at A. Cylinder heads 4a are accurately nested between ridges on or in depressions in insulator plates 139 on completion of assembly. A piston 30 with extensions 31 is shown at BDC in dashed outline. A shaped and holed cage or collar 140 of any suitable material including that of the cylinders 4 connects and aligns the cylinder halves around the piston assembly. Optionally a compressible interlayer 141 of any suitable material is placed between the cage or collar and the cylinder portions, to accommodate varying rates of thermal expansion during engine warm-up. The gage comprises stiffening struts 142 connecting upper and lower bands 143. The cylinder portions are notched at 144 and rest or bear on the ends of the bands 143. Openings between the upper and lower bands define the exhaust ports 145. In an alternative embodiment shown by way of example on the right side of FIG. 22, the starts 146 have inward projection 147 which support and separate the two cylinder halves. Here four struts are shown. In alternative embodiments there are any number of struts.

In FIGS. 1 to 20 ambient air circulates within the enclosure. In other embodiment some or all of the air contains other fluids, including fuel. In further embodiments, ambient air is replaced by other fuels, including when the engines of the invention are adapted to be used as pumps. In the embodiments of FIGS. 5 and 6, the exhaust ports are shown radially outward of the intake ports. In other embodiments, the position of the ports is reversed.

The engines of the invention optionally have exhaust gases directed to any exhaust gas heat energy recovery system, of which the currently most common version includes a turbine, usually linked to a generator. The engine designer has a number of parameters to consider—including exhaust emissions control—before. determining an appropriate overall fuel-air mixture ratio. Whatever that is (it could be stoichiometric), all the fuel is usually burnt in the combustion chamber(s). In an alternative embodiment, where the exhaust heat energy recovery system includes a turbine, only part of the fuel required for a desired overall fuel-air mixture ratio is burnt in the combustion chamber, leaving excess air in the exhaust gas being feed into the turbine. The fuel remaining in the exhaust is supplied to and burnt in the turbine, optionally or alternatively with other fuel, to prove extra work on the turbine shaft, resulting in the overall fuel-air mixture ratio being as determined. A practical option would be to place the exhaust emission control system downstream of the turbine. The power from the turbine is optionally transferred to a linked electrical generator (not shown).

In a high-performance uncooled engine, exhaust can leave the port at temperatures between 1,000° C. and 1,300° C. If some of the air heated by the parasitic losses is mixed with the exhaust before it enters an EHERS, optionally using a turbine, temperatures will be lowered and there will be available oxygen for any fuel to be burnt in the EHERS. In a preferred embodiment fuel for a turbine in the EHERS can be supplied in the conventional way by using some form of combustor or injector. In an alternative embodiment, the reciprocating stage is provided with more fuel than can be completely combusted in the chamber due to provision of a too rich mixture or due to the speed the engine is run at (not giving time for all the fuel to combust in the combustion chamber), leaving the unburnt fuel in the exhaust gas. If the exhaust gas is then mixed with or diluted by air heated by parasitic losses, then the fuel will combine with available oxygen and combust in the EHERS. Such an arrangement would constitute a compound internal combustion engine or genset.

It is proposed to briefly describe those materials which are in general suitable for the high temperature and/or mechanical requirements of the pumps, compressors and IC engines of the invention, and to also describe materials particularly suitable to the filamentary material in particular. Alternatively, material other than described can be used. If the reciprocating device is a pump or compressor, any suitable material may be used, including those mentioned here in connection with other applications and those presently used for pumps and compressors. The invention in any of its embodiments may be made of any suitable material, including those not mentioned here and those which will be devised, discovered or developed in the future. Among the material suitable for use in engines are the high-temperature alloys known as “super alloys,” usually alloys based on nickel, chrome and/or cobalt, with the addition of hardening elements including titanium, aluminum and refractory metals such as tantalum, tungsten, niobium and molybdenum. These super alloys tend to font stable oxide films at temperatures of over 700° C., giving good corrosion protection at ambient temperatures of around 1100° C. Examples include the Nimonic and Iconel range of alloys, with melting temperatures in the 1300° C. to 1500° C. range. At colder temperatures of up to 1000° C. and perhaps higher, certain special stainless steels may also be used. All may be reinforced with ceramic, carbon or metal fibers such as molybdenum, beryllium, tungsten or tungsten plated cobalt, optionally surface activated with palladium chloride or any other appropriate coating or film. In addition, and especially where reinforcement capable of oxidizing is not properly protected by the matrix, the metal may be face hardened. Non-metal fibers or whiskers (often fibers grown as single crystals) such as sapphire-aluminum oxide, alumina, asbestos, graphite, boron or betides and other ceramics or glasses may also act as reinforcing materials, as can certain flexible ceramic fibers. Materials, including those used as filamentary matter, may be coated with ceramic by vapor deposition techniques. Ceramics materials are especially suited to the manufacture of pumps or compressors which process corrosive materials, and of engine piston and cylinder assemblies, as well as engine or reactor volume housings, inter-members and opening linings, because of their generally lower thermal conductivity and ability to withstand high temperatures. Suitable materials include ceramics such as alumina, alumina-silicate, magnetite, cordierite, olivine, fosterite, graphite, silicon nitride, some carbides such as silicon carbide; glass ceramics including such as lithium aluminum silicate, cordierite glass ceramic, “shrunken” glasses such as borosilicate and composites such as sialones, refractory borides, boron carbide, boron silicide, boron nitride, etc. If thermal conductivity is desired, beryllium oxide and silicon carbide may be used. These ceramics or glasses may be fiber or whisker reinforced with much the same material as metals, including carbon fiber, boron fiber, with alumina fibers constituting a practical reinforcement, especially in a high-alumina matrix (the expansion coefficients are the same). It is the very high alumina content ceramics which today might be considered overall the most suited and most available to be used in the invention generally. The ceramic or glass used in the invention may be surface hardened or treated in certain applications, as can metals and often using the same or similar materials, including the metal borides such as of titanium, zirconium and chromium, silicon, etc. Where silicon nitride or other non-oxide ceramics are used in high-performance or long-life engines, or pumps or compressors processing corrosive materials, the surfaces exposed to the worked fluid may be coated with an oxide such as silica, to prevent the base materials surface forming oxides over time and possibly degrading. The filamentary material in the reaction volumes may be made of metals, preferably smoothed and rounded to avoid undue corrosion, or of ceramics or glasses. Other materials which may be particularly suitable are boron filaments, either of pure boron or compounds or composites such as boron-silica, boron carbide, boron-tungsten, titanium diboride tungsten, etc. The filamentary material, especially if ceramic, may easily and conveniently be in the form of wool or fibers, and many ceramic wool or blanket type materials are today manufactured commercially, equally of alumina-silicate, and could readily be adapted to the invention. Such ceramic wool could also be used as a jointing material either alone or as a matrix for a more elastomeric material such as a polymer resin. The material may either be such to have catalytic effect, as in the case of many metals and some ceramics such as alumina, or a surface having catalytic effect may be mounted or coated on a base material, such as ceramic. High temperature lubricants may be necessary for some moving parts, and may be applied either as a liquid or as material coated onto or doped into the surface of a component. They may comprise conventional oil products, or less usual materials such as boron nitride, graphite, silicone fluids and greases, molybdenum compounds, etc.

What I claim is:

1. A thermally insulating enclosure containing an internal combustion (IC) engine., the exterior of said enclosure having apertures or connections for electrical and/or mechanical power out, for fuel in, for air in and for exhaust out, said engine having an operating cycle and:
at least one piston assembly reciprocating in one cylinder assembly to define at least one combustion chamber, said piston mechanically linked to at least one crankshaft and/or at least one electrical generator, said crankshaft and/or generator optionally located within said enclosure;
said cylinder assembly including one or more cylindrical portions and at least one cylinder head;
a frame or structure connecting said cylinder with at least said crankshaft and/or said electrical generator;
a charge gas handling system and at least one charge inlet port to said combustion chamber;
a fuel entry connection in said enclosure communicating with a fuel delivery system;
an exhaust gas emissions control system;
at least one exhaust port from said combustion chamber directing exhaust gas to said exhaust gas emissions control system and/or to an exhaust heat energy recovery system;
wherein said frame is so mounted as to in operation allow movement distinct from and independent of said enclosure.

2. A thermally insulating enclosure containing an internal combustion (IC) engine, the exterior of said enclosure having apertures or connections for electrical and/or mechanical power out, for fuel in, for air in and for exhaust out, said engine having an operating cycle and:
at least one piston assembly reciprocating in one cylinder assembly to define at least one combustion chamber, said piston mechanically linked to at least one crankshaft and/or at least one electrical generator, said crankshaft located within said enclosure, said generator located anywhere;
said cylinder assembly including one or more cylindrical portions and at least one cylinder head;
a frame or structure connecting said cylinder with at least said crankshaft and/or said electrical generator;
a charge gas handling system and at least one charge inlet port to said combustion chamber;
a fuel entry connection in said enclosure communicating with a fuel delivery system;
an exhaust gas emissions control system;
at least one exhaust port from said combustion chamber directing exhaust gas to said exhaust gas emissions control system and/or to an exhaust heat energy recovery system;
wherein said enclosure contains a multiplicity of plenums for passage of charge gas.

3. The enclosure and engine of any one of claims 1 and 2, wherein said enclosure comprises insulation material mounted interiorly of an external skin of said enclosure.

4. The enclosure and engine of any one of claims 1 and 2, wherein said enclosure and engine is installable and removable from a recess of dimensions corresponding to said enclosure, said recess provided in an item of equipment requiring an engine for operation.

5. The enclosure and engine of any one of claims 1 and 2 and a computes loaded with at least one computer program, said program at least partly regulating at least one of said charge gas processing system, said fuel delivery system and exhaust emissions control system.

6. The enclosure and engine of claim 5, wherein said computer is positioned within said enclosure.

7. The enclosure and engine of claim 5, wherein said computer is linked to a control or display panel positioned anywhere.

8. The enclosure and engine of any one of claims 1 through 7, wherein said engine includes in operation a single piston assembly reciprocating in a single cylinder assembly to define a single combustion chamber.

9. The enclosure and engine of any one of claims 1 through 7, wherein said engine includes in operation two piston assemblies reciprocating in a single cylinder assembly to define a single combustion chamber.

10. The enclosure and engine of any one of claims 1 through 7, wherein said engine includes a single piston assembly reciprocating in a single cylinder assembly to define two combustion chambers.

11. The enclosure and engine of any one of claims 1 through 7, wherein said engine includes a single piston assembly both reciprocating and rotating in a single cylinder assembly.

12. The enclosure and engine of any one of claims 1 through 7, wherein said cylinder assembly is at least partly surrounded by a volume for the passage of exhaust gas, said volume at least partly surrounded by thermally insulating material.

13. The enclosure and engine of claim 12, wherein said volume for the passage of exhaust gas and/or said exhaust gas emissions control system contains filamentary material.

14. The enclosure and engine of claim 13, wherein at least part of said filamentary has a catalytic effect.

15. The enclosure and engine of any one of claims 10 and 11, wherein said piston assembly includes at least one piston extension which pierces said cylinder head during at least portion of said operating cycle.

16. The enclosure and engine of claim 15, wherein said piston extension has projections or tongues which penetrate the head during the whole of said operating cycle.

17. The enclosure and engine of any one of claims 10 and 11, wherein said piston assembly has at least one interior volume for the passage of gas,

18. the enclosure and engine of claim 17, wherein said volume has an interior lining of thermally insulating material.

19. The enclosure and engine of claim 17, wherein said interior volume contains a drawbar which is attached to said piston assembly by any appropriate means and is also attached directly or indirectly to a crankshaft or electrical generator, said drawbar supported by bearings directly or indirectly attached to said frame or structure.

20. The enclosure and engine of claim 19, wherein said means comprise optionally holed end pieces bearing on the piston extensions and affixed to said drawbar by any convenient means.

21. The enclosure and engine of any one of claims 9, 10 and 11 wherein two cylinder assembly portions are assembled amend a piston assembly and connected by a holed cage or collar in part surrounding the exterior surfaces of the cylinder portions.

22. The enclosure and engine of claim 21, wherein compressible material is placed between abutting surfaces of said cylinder portions and said cage or collar.

23. The enclosure and engine of any one of claims 8 to 11, wherein exhaust gas is directed to an exhaust heat energy recovery system (EHERS), position in any location.

24. The enclosure and engine of claim 23, wherein portion of charge air or gas passing through said enclosure is directed to said EHERS.

25. The enclosure and engine of claim 24, wherein fuel from any source is supplied to said EHERS, to therein combine with said charge air or gas and combust.

26. The enclosure and engine of any one of claims 23 to 25, wherein energy firm said EHERS is transferred to an electrical generator.
